(19) United States
(12) Patent Application Publication
(10) Pub. No.: US 2025/0018463 A1
(43) Pub. Date: Jan. 16, 2025

(54) PRODUCTION OF SEMISOLID SLURRY WITH TWO OR MORE STIRRING DEVICES

(71) Applicant: COMPTECH RHEOCASTING I SKILLINGARYD AB, Skillingaryd (SE)

(72) Inventor: Per JANSSON, Skillingaryd (SE)

(73) Assignee: COMPTECH RHEOCASTING I SKILLINGARYD AB, Skillingaryd (SE)

(21) Appl. No.: 18/577,047

(22) PCT Filed: Jul. 6, 2022
(86) PCT No.: PCT/SE2022/050689

§ 371 Date: Jan. 5, 2024

(30) Foreign Application Priority Data
Jul. 8, 2021 (SE) 2150909-6

(51) Int. Cl. B22D 1/00; B22D 17/00; F27D 27/00

(52) U.S. Cl. CPC B22D 1/00; B22D 17/007; F27D 27/00

(57) ABSTRACT

A method for producing a semisolid metal slurry, having the steps of providing at least two stirring devices, each having a first end and an opposite second end defining a central axis therebetween, wherein onto each first end a cast metal piece is attached; inserting the first end of each of the at least two stirring devices into a liquid metal bath such that each cast metal piece is submerged in the liquid metal bath; after insertion of the at least two stirring devices into the liquid metal bath, simultaneously rotating the at least two stirring devices with the attached cast metal piece around their respective central axis, and thereby rotating the cast metal pieces in the liquid metal bath; wherein the rotation is continued at least until a majority of the cast metal pieces are molten, such that a semisolid metal slurry is produced.

### TECHNICAL FIELD

The present invention relates generally to a method for producing a semisolid metal slurry and an arrangement for doing the same.

### BACKGROUND ART

Metal casting processes using semisolid metal slurries may be used when detailed and high-quality components are required. Semisolid metal slurries comprise a mixture of the metal in solid phase and in liquid phase, which gives the slurry a higher viscosity compared to fully liquid melts. Furthermore, they often exhibit thixotropic properties, meaning that they flow more easily when under stress, for example during a pressurized casting process. Using semisolid slurries, as compared to fully liquid metal melts, is beneficial for many reasons. Since semisolid slurries solidify more slowly, they are able to fill all cavities of the tool before solidification. Furthermore, since nucleation points in the form of solid grains are already present in the slurry, a higher degree of control over the resulting microstructure is achieved. These and other beneficial properties have gained semisolid slurries increased attention from large-scale industries, such as the automotive industry. This inevitably increases the need to produce larger quantities of semisolid metal slurries without compromising neither cost, time nor quality. Today, this is a problem for the companies which provide solutions for production of semisolid slurries.

One melt preparation process for semisolid slurries is known as Rheocasting, and is disclosed in Swedish granted patent SE 538596. The patent discloses a method where a liquid metal melt is cast onto a mechanical stirrer, and wherein the cast piece, sometimes known as an Enthalpy Exchange Material (EEM), and the stirrer are lowered into a liquid metal bath. The solid EEM has a lower temperature than the liquid metal bath and, combined with the endothermic melting of the EEM, the liquid metal bath is cooled and starts to solidify. By simultaneously using the mechanical stirrer to break up dendritic networks formed during the solidification, a high-quality semisolid slurry is obtained.

The size of one batch of produced semisolid slurry is known as the shot weight. The shot weight thus comprises both the weight of the liquid metal in the liquid metal bath and the cast piece on the stirrer when it has molten of the stirrer. If a larger shot weight is desired, both the weight of the liquid metal and the weight of the cast piece on the stirrer would have to be increased, in order to provide the same amount of cooling from cast piece to the liquid metal bath. However, increasing the weight of the cast piece on the stirrer presents many difficulties. For example, the melting time of the cast piece in the liquid melt increases, and increased lead times of only a few seconds may result in high costs. Furthermore, the cast piece commonly has the shape of a cylinder, and increasing the weight of the cast piece, thus increasing the volume of the cylinder, results in a larger surface area of the cast piece and more cooling locally in the melt thus making it more difficult to break up the solidified dendritic networks and disperse the solid particles. It may even lead to the formation of a solid shell around the cast piece which is too great to melt away. All of this may drastically decrease the quality of the semisolid slurry.

Therefore, there is a need to improve processes for producing semisolid slurries, in order to make it suitable for larger shot weights, shorter lead times and a higher quality slurry.

### SUMMARY OF THE INVENTION

An object of the present invention is to overcome at least some of the problems outlined above. Therefore, there is provided method for producing a semisolid metal slurry, comprising the steps of providing at least two stirring devices, each having a first end and an opposite second end defining a central axis therebetween, wherein onto each first end a cast metal piece is attached; inserting the first end of each of the at least two stirring devices into a liquid metal bath such that each cast metal piece is submerged in the liquid metal bath; after insertion of the at least two stirring devices into the liquid metal bath, simultaneously rotating the at least two stirring devices with the attached cast metal piece around their respective central axis, and thereby rotating said cast metal pieces in the liquid metal bath; wherein the rotation is continued at least until a majority of the cast metal pieces are molten, such that a semisolid metal slurry is produced.

Providing at least two stirring devices gives many advantages. The stirring may be improved, at least because of the increased shearing of the slurry provided by having at least two stirring devices rotating simultaneously. Improved stirring provides finer solid particles, as well as faster and more even distribution of solid particles in the slurry. In addition, for example in a case where a cast metal piece does not have the same chemical composition as the liquid metal bath, the stirring increases and/or improves the homogenization of the composition. More efficient homogenization may also relate to the temperature distribution in the slurry. The improved stirring may be attributed to the stirring devices having the cast metal pieces, which supply the cooling, attached thereto. A high stirring/shearing is thus inherently provided in the same position as the solidified material forms at the surface of the cast metal pieces and thus efficiently breaks up the solidified material and distributes it out into the melt. Furthermore, having at least two stirring devices provides the possibility of altering the size of the cast metal pieces. That is, the shot weight may be increased by increasing the number of stirring devices, rather than increasing the size of the cast metal pieces. Smaller cast metal pieces lead to a smaller surface area for each piece and thus a decreased melting time, problems related with a too high initial cooling are avoided, and an increased shearing is provided between the cast metal pieces. A more time, cost and energy efficient process may thus be achieved. A higher quality semisolid slurry is furthermore achieved.

The desired solid particle content is an important property of the semisolid slurry. That is, the solid particle share of the finished semisolid slurry. What solid particle content is desired may depend on the intended use of the slurry. The relation between the weight of the liquid metal in the liquid metal bath and the weight of the cast metal pieces, affects the solid particle content. Generally, it can be said that a higher share solid weight in relation to liquid weight gives a higher solid particle content due to an increased cooling from the solid metal. Thus, in prior art, when a higher solid particle content is desired, a higher share of the shot weight must originate from the cast metal pieces. Thus, if only one single stirring device were to be used, achieving a higher solid particle content would inevitably entail increasing the weight of the cast metal piece. As mentioned above, this is not desirable. Therefore, higher solid particle contents may be produced in a shorter time by providing at least two stirring devices having cast metal pieces attached thereon, each having a smaller diameter than if only one single stirring device had been used to provide a corresponding weight of cast solid metal.

In an embodiment of the present disclosure, the rotating of the at least two stirring devices further comprises rotating the at least two stirring devices around a common axis.

Rotating both the individual stirring devices around their own axis, and around a common axis increases the stirring, and the shearing, which is advantageous for the reasons outlined above.

In an embodiment of the present disclosure, the rotation of the at least two stirring devices around their respective central axis is in the same direction.

In an embodiment of the present disclosure, the rotation of one of the at least two stirring devices around its respective central axis is in a first direction, and the rotation of another of the at least two stirring devices around it its respective central axis is in a second direction, opposite the first direction.

The rotational scheme of the at least two stirring devices may be optimized to provide optimal stirring, and thus optimal slurry properties. This is an advantage compared to having only one stirring device.

In an embodiment of the present disclosure, the method comprises controlling the temperature of the cast metal pieces, before the step of inserting the at least two stirring devices into the liquid metal bath, to have a temperature in the range 80-200° C.

The temperature of the cast metal pieces is one of the parameters which determines the amount of cooling provided to the liquid metal bath. It affects both the properties of the slurry, and the melting time of the cast metal pieces. When at least two stirring devices are used, the size of each cast metal piece may be smaller than if only one stirring device were provided, and thereby lower temperatures of the cast metal pieces are possible.

In an embodiment of the present disclosure, the step of providing at least two stirring devices comprises casting of the cast metal pieces onto the first end of each stirring device.

In an embodiment of the present disclosure, the casting is performed simultaneously for each of the cast metal pieces by means of the same casting inlet.

By using the same inlet, also known as a riser, the process is made more efficient. Furthermore, simultaneous casting provides that the degree solidification, the temperature, and other properties of the cast metal pieces are equal.

In an embodiment of the present disclosure, after casting onto a respective stirring device, a cooling step is provided comprising cooling of the cast metal pieces to a temperature corresponding to a temperature at which the cast metal pieces are inserted into the liquid metal bath.

Since the cast metal pieces after casting are brought directly to the temperature at which they are inserted into the liquid metal bath, there is no need for re-heating the cast metal pieces.

In an embodiment of the present disclosure, the casting is performed in a mould adapted such that the cast metal piece obtains the shape of a cylinder, and wherein a radial thickness of the cylinder is not more than 40 mm, preferably not more than 35 mm, more preferably not more than 30 mm.

When at least two stirring devices are used, the size of each cast metal piece may be smaller than if only one stirring device were provided, and thereby the melting time may be decreased. The size and shape of the cast metal piece is commonly adapted to each slurry making process. However, it may be generally stated that it has to be large enough to give adequate cooling to the liquid metal bath in order to form the semisolid slurry, and at the same time be small enough such that the entire cast metal piece is molten when the slurry is ready for casting. It is important to avoid having to remove the stirring device from the slurry bath before the cast metal piece it is molten, thus having to provide a separate process for removing the residue on the stirring device, as well as wasting unutilized material.

In another aspect of the present disclosure, there is provided an arrangement for producing a semisolid metal slurry, comprising at least two stirring devices, each having a first end and an opposite second end defining a central axis therebetween, and wherein each of the at least two stirring devices comprises a cast metal piece attached onto each first end; and a stirring apparatus arranged for inserting the first end of each of the at least two stirring devices into a liquid metal bath such that each cast metal piece is submerged in the liquid metal bath; after insertion of the at least two stirring devices into the liquid metal bath, simultaneously rotating the at least two stirring devices with the attached cast metal piece around their respective central axis, and thereby rotating said cast metal pieces in the liquid metal bath; wherein the rotation is continued at least until a majority of the cast metal pieces are molten, such that a semisolid metal slurry is produced.

In an embodiment of the present disclosure, the at least two stirring devices are between two and four each having a cast metal piece attached to a first end thereof.

In an embodiment of the present disclosure the arrangement is further arranged for casting in a mould adapted such that the cast metal piece obtains the shape of a cylinder, and wherein a radial thickness of the cylinder is not more than 40 mm, preferably not more than 35 mm, more preferably not more than 30 mm.

### BRIEF DESCRIPTION OF DRAWINGS

The invention is now described, by way of example, with reference to the accompanying drawings, in which:

FIGS. 1a and 1b show an embodiment of the invention comprising two stirring devices;

FIGS. 2a and 2b show an embodiment of the invention comprising three stirring devices;

FIG. 3 shows an embodiment of a stirring device;

FIG. 4 shows one possible rotation pattern of an arrangement according to the present disclosure;

FIG. 5 shows a method for producing semisolid slurry according to the present disclosure.

### DESCRIPTION OF EMBODIMENTS

In the following, a detailed description of a method for producing a semisolid metal slurry and an arrangement for doing the same is disclosed. Disclosed embodiments should be seen as illustrative examples and not as limiting to the scope of the invention.

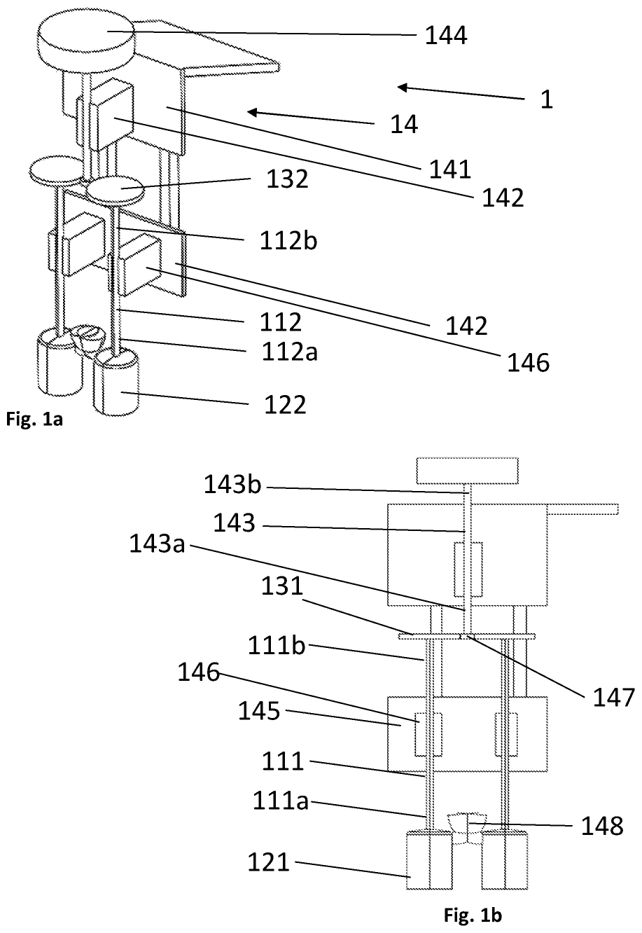

FIGS. 1a and 1b display an embodiment of an arrangement 1 according to the present disclosure, generally comprising first and second stirring device 111, 112 having a first end 111a, 112a and an opposite second end 111b, 112b, wherein a first and a second cast metal piece 121, 122 is attached to each first end 111a, 112a of the first and second stirring device 111, 112. The arrangement 1 furthermore comprises a stirring apparatus 14. The stirring apparatus 14 is arranged to simultaneously hold the second end 111b, 112b of each of the first and second stirring device 111, 112. The stirring apparatus 14 is furthermore arranged to rotate the first and second stirring device 111, 112. When the first end 111a, 112a of each of the first and second stirring device 111, 112 are inserted into a liquid metal bath, the rotation by means of the stirring apparatus 14 provides stirring in the melt. The rotation and stirring will be described more in detail in relation to FIG. 4.

The disclosure is based on the insight that by simultaneously providing at least two stirring devices during the process of producing a semisolid slurry, each having the cast metal piece attached to the first end thereof, it is possible to scale up the process, that is, produce more semisolid metal slurry, without compromising production time, quality or cost.

The insight arose from the need to optimize the slurry making process and achieving desired properties of the finished semisolid slurry. The inventors have found that, to this end, not only the number of stirring devices may be increased, but the dimensions of the cast metal pieces may also be optimized.

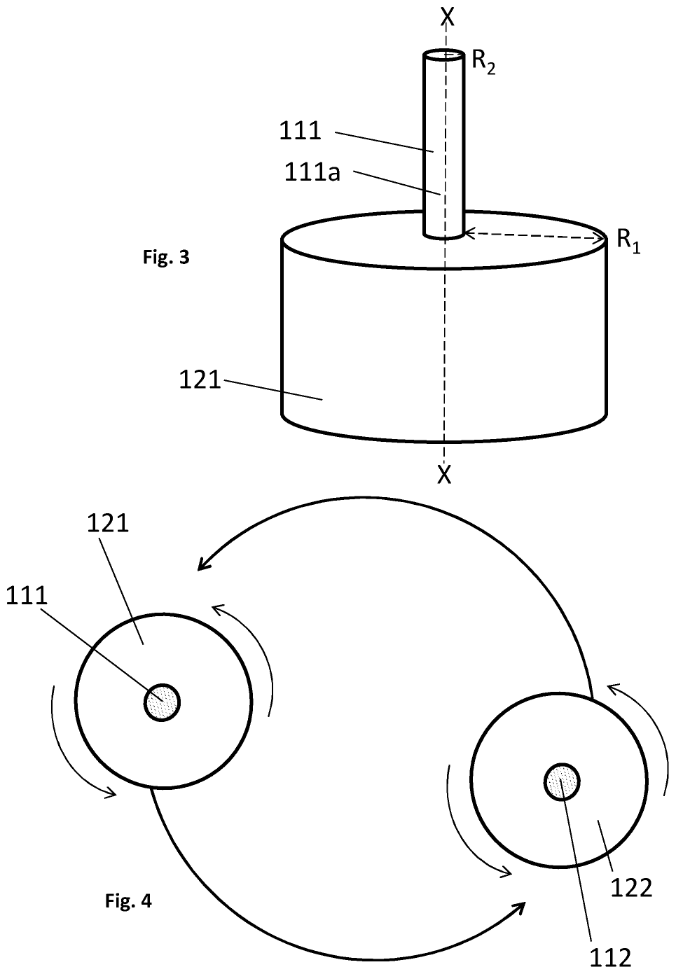

The inventors have found that below certain radiuses (melting radius R1 in FIG. 3), the melting time of the cast metal pieces is optimal, leading to decreased lead times during the production of the semi solid slurry. This goes against what is commonly practiced, which is, in order to increase the shot weight, one needs to increase the size of the cast metal pieces. On the contrary, the inventors have found that when a melting radius of a cast metal piece exceeds 40 mm, suboptimal process conditions are achieved. This will be described more in detail in relation to FIG. 3. Therefore, when a larger shot weight is desired, according to the present disclosure, at least two stirring devices are provided having cast metal pieces attached thereon, each having a smaller radius than if only one single stirring device had been used to provide a corresponding weight of solid metal. A larger desired shot weight would instead, according to the present disclosure, entail providing a larger number of stirring devices.

In FIGS. 1a and 1b, the first and second stirring device 111, 112 each comprise an elongated shaft extending between the first end 111a, 112a and the second end 111b, 112b. The first and second stirring device 111, 112 have a circular cross-section. In one embodiment, the circular cross-section has a diameter of 14 mm. In other embodiments, other diameters are possible. As disclosed above, the first and second stirring device 111, 112 have the first and second cast metal piece 121, 122 attached to the first end 111a, 112a of each of the first and second stirring device 111, 112. In the embodiment displayed in FIGS. 1a and 1b, the first and second cast metal piece 121, 122 have a cylinder shape and preferably essentially equal shape and size. The second ends 111b, 112b each comprise, at a tip thereof, a first and second rotation transfer member 131, 132 in the shape of a cylinder, the shape may also be seen as a circular plate having a thickness. The first and second rotation transfer member 131, 132 are arranged in a plane essentially perpendicular to the elongated shaft.

In FIGS. 1a and 1b, the stirring apparatus 14 is displayed. The stirring apparatus 14 comprises a first back wall 141, a first guiding unit 142 arranged on the first back wall 141, a central shaft 143, kept in an upright and/or essentially vertical position by the first guiding unit 142 and comprising a first, bottom end 143a and a second, upper end 143b. At the second, upper end 143b, a third rotation transfer member 144 is arranged. The stirring apparatus further comprises a second back wall 145 and a second guiding unit 146 arranged on the second back wall 145 and arranged to keep the first and second stirring device 111, 112 in an upright and/or essentially vertical position.

A motor driven rotating spindle (not shown) is arranged to come into contact with the third rotation transfer member 144 for rotating the central shaft 143. When the rotating spindle contacts the third rotation transfer member 144, the rotation is transferred to the central shaft 143. The rotation of the central shaft 143 is transferred into rotation of the first and second stirring device 111, 112 by means of the first and second rotation transfer member 131, 132 on the first and second stirring device 111, 112, which are in contact with the central shaft 143 at a position at the first, bottom end 143a of the central shaft 143. To this end, a fourth rotation transfer member 147 is arranged at this position.

In an alternative embodiment, the first and second rotation transfer member of the stirring devices are both directly in contact with the motor driven rotating spindle. In this embodiment, there is no need for the central shaft, since the rotational motion is transferred directly from the spindle to the stirring devices.

The stirring apparatus 14 allows for at least two kinds of rotation. Firstly, individual rotation of each the first and second stirring device 111, 112 around their respective central axis, wherein the respective central axis is defined as an axis running through the elongated shaft of each respective stirring device, extending between the first end 111a, 112a and the second end 111b, 112b thereof. Secondly, a relative rotation around an axis common to the first and second stirring device 111, 112 which will be described more in detail in relation to FIG. 4. The stirring apparatus 14 may hold the first and second stirring device 111, 112 as they are inserted into the liquid metal bath during production of the semisolid slurry. Preferably, the stirring apparatus 14 furthermore holds the first and second stirring device 111, 112 during the casting and cooling step, as will be described below.

In FIGS. 1a and 1b, a riser 148 is also visible between the first and second cast metal piece. The riser is a residue from casting, arranged to compensate for solidification shrinkage. The riser 148 is removed from the cast metal piece 121, 122 before they are inserted into the liquid metal bath. The removal of the riser 148 may be through any suitable method, in one embodiment the riser 148 is removed through plasma-cutting. As can be seen from the figure, the riser connects the first and second cast metal piece 121, 122. This is due to how they are cast. The first and second cast metal piece 121, 122 are produced through simultaneous casting, wherein liquid metal is simultaneously poured into both molds, through the common riser 148. Furthermore, the first and second stirring device 111, 112 are also arranged in the molds during casting such that the first and second cast metal piece 121, 122 are cast onto, and thereby attached to, the first and second stirring device 111, 112.

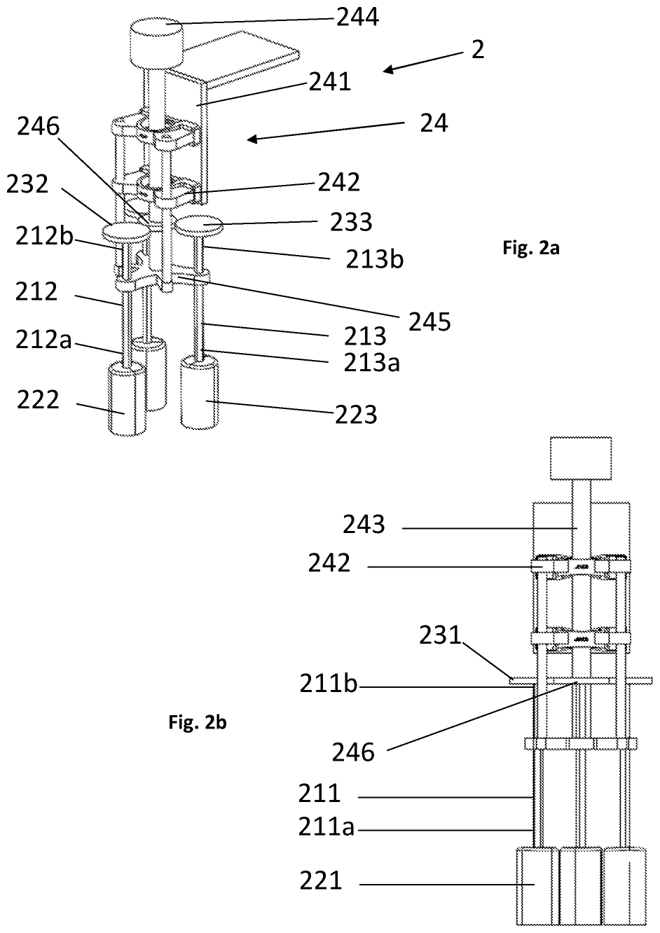

FIGS. 2a and 2b display an embodiment of an arrangement 2 of the present disclosure, comprising a first, a second and a third stirring device 211, 212, 213. The first, second and third stirring device 211, 212, 213 are preferably arranged equidistantly from each other, thus having a triangle arrangement. Other arrangements are also possible.

The first, second and third stirring device 211, 212, 213 each comprise an elongated shaft having a first end 211a, 212a, 213a and a second end 211b, 212b, 213b. The first, second and third stirring device 211, 212, 213 have a first, a second and a third cast metal piece 221, 222, 223 attached to the first end 211a, 212a, 213a of each of the first, second and third stirring device 211, 212, 213. In the embodiment of FIGS. 2a and 2b, the first, second and third cast metal piece 221, 222, 223 have a cylinder shape and preferably essentially equal shape and size. The second ends 211b, 212b, 213b each comprise, at a tip thereof, a first, second and third rotation transfer member 231, 232, 233 in the shape of a cylinder, the shape may also be seen as a circular plate having a thickness. The first, second and third rotation transfer member 231, 232, 233 are arranged in a plane essentially perpendicular to the elongated shaft.

FIGS. 2a and 2b further display an embodiment of the stirring apparatus 24. The stirring apparatus 24 comprises a back wall 241, a first guiding unit 242 arranged on the first back wall 241. In this embodiment, the first guiding unit 242 comprises an upper and a bottom part. The stirring apparatus further comprises a central shaft 243, kept in an upright and/or essentially vertical position by the first guiding unit 242 and comprising a first, bottom end 243a and a second, upper end 243b. At the second, upper end 243b, a fourth rotation transfer member 244 is arranged. Two side shafts are also arranged in the first guiding unit 242, to increase stability. A second guiding unit 245 is furthermore arranged at the first, bottom end 243a of the central shaft 243 as well as at a bottom end of the two side shafts, arranged to keep the first, second and third stirring devices 211, 212, 213 in an upright and/or essentially vertical position.

In another embodiment of the present disclosure, an arrangement is provided having a first, second, third and fourth stirring device. In other embodiments, more than four stirring devices are provided.

A motor driven rotating spindle (not shown) is arranged to come into contact with the fourth rotation transfer member 244 for rotating the central shaft 243. When the rotating spindle contacts the fourth rotation transfer member 244, the rotation is transferred to the central shaft 243. The rotation of the central shaft 243 is transferred into rotation of the first, second and third stirring devices 211, 212, 213 by means of the first, second and third rotation transfer member 231, 232, 233 on the stirring devices, which are in contact with the central shaft 243. In this embodiment, the first, second and third rotation transfer member 231, 232, 233 are in contact with the central shaft 243 at a position above the first, bottom end 243a of the shaft. To this end, a fifth rotation transfer member 246 is arranged at this position.

Below, the invention in described with reference to FIGS. 3-5. It will be understood that even though reference numerals correspond to the embodiment displayed in FIGS. 1a and 1b, the same applies to the embodiment in FIGS. 2a and 2b as well as all other embodiments of the invention, where applicable.

FIG. 3 displays the first end 111a of the stirring device 111. As described above, a cast metal piece 121 is attached at the first end 111a. The cast metal piece 121 preferably has a cylindrical shape. In FIG. 3, the melting radius R1 is shown. The melting radius is here defined as the thickness of the cast metal piece 121 outside the stirring device 111, and as such determines the melting time of the cast metal piece. The melting time is the time it takes for a cast metal piece 121 to be essentially completely molten. A larger melting radius thus entails a longer meting time. The melting radius is measured from a point on the circumference of the elongated shaft of the stirring device 111, to a point on the circumference of the cast metal piece, positioned radially outwards from the point on the stirring device. The melting radius R1 may also be seen as the radius to the center of the cylinder minus the radius R2 of the stirring device. Thus, a melting radius may be increased/decreased by changing the radius of the shaft of the stirring device 111. Preferably, the melting radius R1 is less than 40 mm, preferably less than 35 mm, even more preferably less than 30 mm. Thus, according to the present disclosure, a higher total weight of the cast metal piece 121 is preferably achieved by increasing the number of stirring devices 111, rather than increasing the melting radius R1 of each cast metal piece 121 above the preferred melting radius.

FIG. 4 displays a rotational scheme for the rotation of the stirring devices 111, 112, by means of the stirring apparatus 14, in the liquid metal bath. In FIG. 4, two stirring devices 111, 112 with the respective cast metal piece 121, 122 are displayed, but it will be understood that the same applies when three, four or more stirring devices are provided.

The rotational scheme displays both rotation of the individual stirring devices 111, 112 around their respective central axis (axis X-X in FIG. 3), as well as rotation of all stirring devices 111, 112 around a common axis.

The rotation of the individual stirring devices 111, 112 may be in the same or opposite directions. In an embodiment where three or more stirring devices are provided, one or more of the stirring devices may rotate in a first direction, and one or more of the remaining stirring devices may rotate in a second, opposite direction.

The common axis is an axis parallel to at least one of the stirring devices'111, 112 central axis. The common axis may be equidistant from the stirring devices 111, 112 or offset and thus closer to one of them. The common axis may for example coincide with the extension of the central shaft 143 of the stirring apparatus 14. The rotation around a common axis may coincide with the direction of the individual stirring devices 111, 112 or not. The rotation may be at various speed. Furthermore, the rotational speed of the individual stirring devices 111, 112 may be the same or different from each other. Furthermore, the rotational speed of the individual stirring devices 111, 112 may be the same or different from the rotation around a common axis.

Because more than one stirring device is provided in all embodiments of the present disclosure, a better stirring of the semisolid slurry is achieved. A better stirring may for example mean a higher shearing during stirring, due to the fact that the slurry is sheared in between the cast metal pieces 121, 122, as well as between the cast metal piece 121, 122 and walls of the ladle containing the slurry. A higher shearing provides finer solid particles in the semisolid slurry. A better stirring may also provide better distribution of the solid particles in the melt. A better stirring may also mean higher removal rate of solid particles from the vicinity of the cast metal piece 121, 122, and thereby a faster melting of the cast metal piece 121, 122. A better stirring may also mean more and faster homogenization of variations in chemical composition. A better stirring may also mean a more even temperature distribution.

The stirring may be combined with additional stirring from external stirring means.

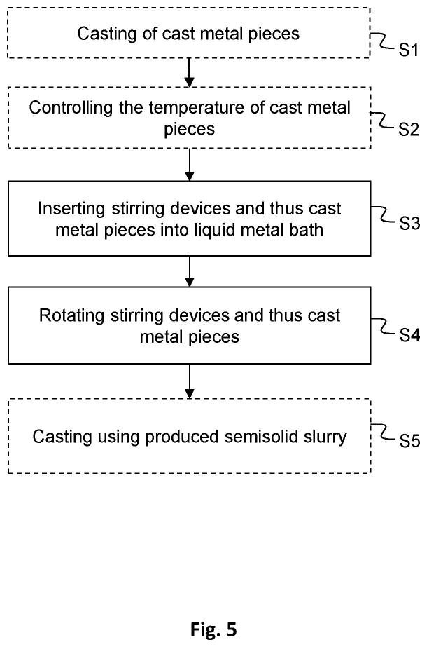

The method of the present disclosure will now be described with reference to FIG. 5. The method of the present disclosure provides an efficient way of producing semisolid slurries, generally comprising the steps described below. It will be understood that even though reference numerals correspond to the embodiment displayed in FIG. 1, the same applies to the embodiment in FIG. 2 as well as all other embodiments of the invention, where applicable.

The first step comprises casting S1 of the cast metal pieces 121, 122. A liquid metal melt is provided in at least two molds together with a first end 111a, 112a of a respective stirring device, such that the liquid metal in each mold solidifies into the cast metal pieces 121, 122 and is thereby cast onto the first end 111a, 112a of the respective stirring device 111, 112 and thus attached thereto. The casting of the cast metal pieces 121, 122 is preferably done simultaneously, and even more preferably done through the same casting inlet, also known as a riser 148. The mold preferably has an inner shape such that the obtained cast metal pieces 121, 122 have a cylindrical shape. The mold furthermore preferably has an inner radius such that the obtained cast metal pieces 121, 122 have a radius corresponding to the above-described desired melting radius R1. The first and second stirring device 111, 112, together with the attached cast metal pieces 121, 122, are subsequently removed from the molds. During the casting step S1, each second end 111b, 112b is preferably held by the stirring apparatus 14.

The casting is preferably followed by a temperature controlling step S2. The temperature of the cast metal pieces 121, 122 is preferably controlled such that they have a temperature in the range 80-200° C., more preferably 80-140° C. This temperature corresponds to a temperature at which the cast metal pieces 121, 122 are inserted into the liquid metal bath. The temperature of the cast metal pieces 121, 122 is of high importance. The temperature may not be too high as the cast metal pieces 121, 122 must provide sufficient cooling to the liquid metal bath to form the semisolid slurry. The temperature may not be too low as the cast metal pieces 121, 122 must not freeze the liquid metal bath. Furthermore, the cast metal pieces 121, 122 should preferably not cool below a temperature at which they are inserted into the melt (in the subsequent step), since this would require re-heating of the cast metal pieces 121, 122 before insertion, thus making the slurry making process less energy and time efficient. In a preferred embodiment, controlling the temperature S2 comprises cooling of the cast metal pieces 121, 122, preferably cooling to the temperature at which the cast metal pieces 121, 122 are inserted into the liquid metal bath. During the temperature controlling step S2, each second end 111b, 112b is preferably held by the stirring apparatus 14.

By means of the stirring apparatus 14, the first end 111a, 112a of each of the first and second stirring device 111, 112 are inserted S3 into the ladle containing the liquid metal bath. The insertion S3 of the first and second stirring device 111, 112 is preferably performed simultaneously. In other words, the first and second stirring device 111, 112 are preferably inserted S3 together. The first and second stirring device 111, 112 are preferably inserted S3 such that each cast metal piece 121, 122 is submerged in the liquid metal bath, and preferably such that each cast metal piece 121, 122 is simultaneously submerged. The insertion S3 of the first and second stirring device 111, 112 is preferably performed before the stirring is initiated.

The steps of casting S1, controlling the temperature S2 and insertion S3 into the melt are preferably a continuous process where unnecessary re-heating, and thus wasting of time and energy, is avoided.

After insertion S3, the first and second stirring device 111, 112 are rotated S4 in order to stir the liquid metal bath. The rotating S4 of the first and second stirring device 111, 112 is preferably performed simultaneously. Simultaneously rotating the first and second stirring device 111, 112 should be understood as being rotated simultaneously for the majority of the melting of the cast metal piece 121, 122. The rotating S4 of the first and second stirring device 111, 112 may start or stop at the same time or at different times. The first and second stirring device 111, 112 are kept in the liquid metal bath until the semisolid slurry has formed and/or until a majority of the cast metal pieces 121, 122 are molten. Preferably, the cast metal pieces 121, 122 should be essentially completely molten when the stirring devices 111, 112 are withdrawn from the ladle, in order to avoid unnecessary subsequent cleaning of the stirring devices 111, 112. Preferably, the slurry making process is optimized such that desirable properties of the semisolid slurry are achieved essentially at the same time as the cast metal pieces 121, 122 are molten from the respective stirring device. This optimization process is facilitated by providing at least two stirring devices, compared to only using one.

Subsequently, the stirring devices 111, 112 are removed from the finished semisolid slurry, and the semisolid slurry in provided in a casting process S5.

As stated above, the temperature of the cast metal pieces affects, together with other parameters, the amount of cooling provided from the cast metal pieces to the liquid metal bath. It has furthermore been clarified in the present disclosure that the size of the cast metal pieces has an effect on the cooling, where larger pieces provide more cooling. Where only one stirring device is provided (in prior art), one degree of freedom is lost, as the dimensions may not be altered—a larger shot weight inevitably requires a larger cast metal piece. However, by providing at least two stirring devices and thus having the possibility of optimizing both dimension and temperature, high control and quality of process parameters, as well as slurry properties, may be achieved.

Preferred embodiments of a method and an arrangement have been disclosed. However, a person skilled in the art realizes that this can be varied within the scope of the appended claims without departing from the inventive idea.

All the described alternative embodiments above or parts of an embodiment can be freely combined or employed separately from each other without departing from the inventive idea as long as the combination is not contradictory.

1.-12. (canceled)

13. A method for producing a semisolid metal slurry, comprising the steps of:
providing at least two stirring devices, each having a first end and an opposite second end defining a central axis therebetween, wherein onto each first end a cast metal piece is attached;
inserting the first end of each of the at least two stirring devices into a liquid metal bath such that each cast metal piece is submerged in the liquid metal bath;
after insertion of the at least two stirring devices into the liquid metal bath, simultaneously rotating the at least two stirring devices with the attached cast metal piece around their respective central axis, and thereby rotating said cast metal pieces in the liquid metal bath;
wherein the rotation is continued at least until a majority of the cast metal pieces are molten, such that a semisolid metal slurry is produced.

14. The method according to claim 13, wherein the rotating of the at least two stirring devices further comprises
rotating the at least two stirring devices around a common axis.

15. The method according to claim 13, wherein the rotating of the at least two stirring devices around their respective central axis is in the same direction.

16. The method according to claim 13, wherein the rotating of one of the at least two stirring devices around its central axis is in a first direction, and the rotation of another of the at least two stirring devices around its central axis is in a second direction, opposite the first direction.

17. The method according to claim 13, further comprising controlling the temperature of the cast metal pieces, before the step of inserting the at least two stirring devices into the liquid metal bath, to have a temperature in the range 80-200° C.

18. The method according to claim 13, further comprising, before the step of providing at least two stirring devices:
casting of the cast metal pieces onto the first end of each stirring device.

19. The method according to claim 18, wherein the casting is performed simultaneously for each of the cast metal pieces by means of the same casting inlet.

20. The method according to claim 18, further comprising the step:
after the casting onto a respective stirring device, cooling of the cast metal pieces to a temperature corresponding to a temperature at which the cast metal pieces are to be inserted into the liquid metal bath.

21. The method according to claim 18, wherein the casting is performed in a mould adapted such that the cast metal piece obtains the shape of a cylinder, and wherein a radial thickness of the cylinder is not more than 40 mm, preferably not more than 35 mm, more preferably not more than 30 mm.

22. An arrangement for producing a semisolid metal slurry, comprising:
at least two stirring devices, each having a first end and an opposite second end defining a central axis therebetween, and wherein each of the at least two stirring devices comprises a cast metal piece attached onto each first end; and
a stirring apparatus arranged for:
inserting the first end of each of the at least two stirring devices into a liquid metal bath such that each cast metal piece is submerged in the liquid metal bath;
after insertion of the at least two stirring device into the liquid metal bath, simultaneously rotating the at least two stirring devices with the attached cast metal piece around their respective central axis, and thereby rotating said cast metal pieces in the liquid metal bath;
wherein the rotation is continued at least until a majority of the cast metal pieces are molten, such that a semisolid metal slurry is produced.

23. The arrangement according to claim 22, the at least two stirring devices being between two and four, each having a cast metal pieces attached to a first end thereof.

24. The arrangement according to claim 22, further arranged for casting in a mould adapted such that the cast metal piece obtains the shape of a cylinder, and wherein a radial thickness of the cylinder is not more than 40 mm, preferably not more than 35 mm, more preferably not more than 30 mm.
